(19) United States
(12) Patent Application Publication
(10) Pub. No.: US 2012/0044695 A1
(43) Pub. Date: Feb. 23, 2012

(54) HEAT DISSIPATION STRUCTURE FOR LED LAMP

(76) Inventor: Hsu Li Yen, Taipei County (TW)

(21) Appl. No.: 12/859,969

(22) Filed: Aug. 20, 2010

(51) Int. Cl. F21V 29/00; F28F 13/00

(52) U.S. Cl. 362/294; 362/373; 165/80.2

(57) ABSTRACT

An improved heat dissipation structure for an LED lamp is provided. The heat dissipation structure, featuring low cost and a significant heat dissipation effect, includes a metal lamp housing. The inner side of the metal lamp housing is formed with a light-reflecting surface and a planar mounting surface for mounting and positioning the LED lamp. The backside of the mounting surface is mounted with a heat dissipating block. The heat generated by the LED lamp during light emission is conducted through the mounting surface of the metal lamp housing to the heat dissipating block, which absorbs the heat and dissipates the heat rapidly.

### BACKGROUND OF THE INVENTION

1. Technical Field The present invention relates to an improved heat dissipation structure for dissipating the heat generated by a light-emitting diode (LED) lamp.

2. Description of Related Art

The conventional lamps cause pollution during their manufacturing and recycling processes and consume a lot of electricity during use. By contrast, LED lamps are pollution-free while being produced and recycled, operate at low power consumption, provide high luminosity, and therefore have been a preferred substitution for the conventional lamps.

One major drawback of LED lamps is that they generate high heat rapidly when lit, and the heat may accelerate the aging of or even damage the LED lamps. In view of the fact that LED lamps tend to generate significant heat and age prematurely as a result, the inventor of the present invention conducted extensive research and experiments and finally succeeded in developing a low-cost structure which can dissipate heat rapidly to keep an LED lamp in a low-temperature state and hence increase its service life.

### BRIEF SUMMARY OF THE INVENTION

The present invention relates to an improved heat dissipation structure for an LED lamp. More particularly, a low-cost heat dissipation structure configured for an LED lamp and having a significant heat dissipation effect is disclosed. The heat dissipation structure includes a metal lamp housing whose inner side is formed with a light-reflecting surface and a planar mounting surface for mounting and positioning an LED. The backside of the mounting surface is further mounted with a heat dissipating block. Thus, the heat generated by the LED lamp during light emission is conducted to the heat dissipating block via the mounting surface of the metal lamp housing, so as for the heat dissipating block to absorb the heat and dissipate the heat rapidly.

The primary object of the present invention is to provide a heat dissipation structure for an LED lamp, wherein a metal lamp housing has a mounting surface for mounting the LED lamp and transmitting the heat generated by the LED lamp to a heat dissipating block, which is configured to absorb and then dissipate the heat rapidly. Thus, the LED lamp is maintained in a constant low-temperature state and prevented from premature aging.

### BRIEF DESCRIPTION OF THE SEVERAL VIEWS OF THE DRAWINGS

The structure as well as a preferred mode of use, further objects, and advantages of the present invention will be best understood by referring to the following detailed description of an illustrative embodiment in conjunction with the accompanying drawings, in which:

FIG. 1 is an assembled perspective view and an exploded perspective view of a heat dissipation structure for an LED lamp according to the present invention;

FIG. 2 is another assembled perspective view and another exploded perspective view of the heat dissipation structure shown in FIG. 1; and

FIG. 3 is an assembled sectional view of the heat dissipation structure shown in FIG. 1,

### DETAILED DESCRIPTION OF THE INVENTION

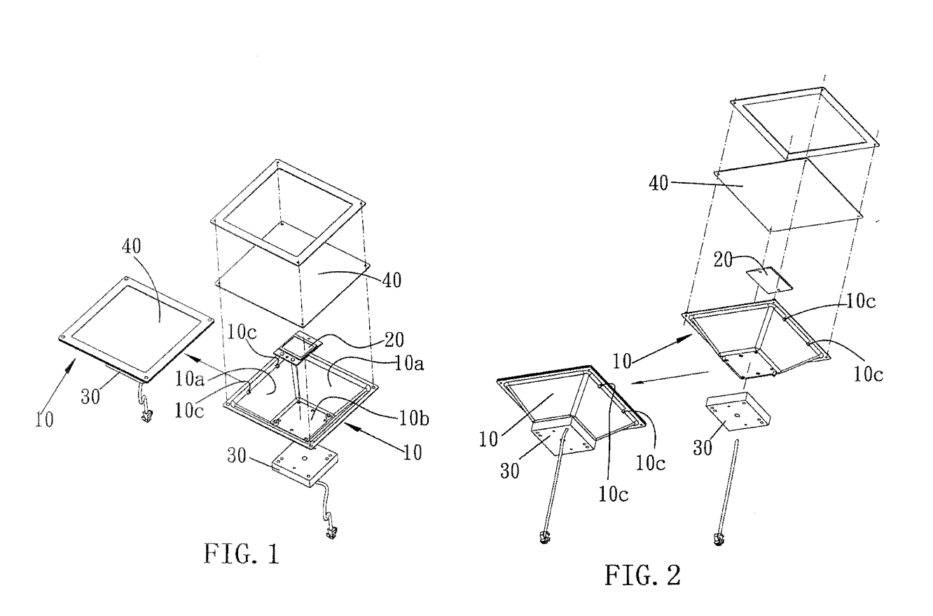

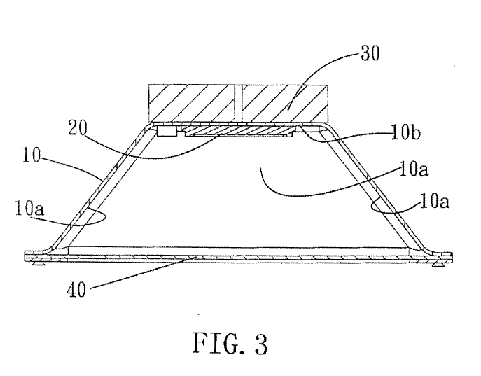

Referring to FIG. 1 and FIG. 2 for different assembled perspective views and exploded perspective views of an embodiment of the present invention, a heat dissipation structure for an LED lamp includes a metal lamp housing 10. The inner side of the metal lamp hosing 10 is formed with a light-reflecting surface 10a, a plurality of vent holes 10c, and a planar mounting surface 10b, wherein the mounting surface 10b is configured for mounting and positioning an LED lamp 20. In addition, a heat dissipating block 30 is mounted on the backside of the mounting surface 10b, as shown in FIG. 2, and a light-permeable cover 40 is provided at the opening of the metal lamp housing 10, as shown in FIG. 3.

FIG. 3 is an assembled sectional view of the heat dissipation structure of the present invention. As shown in the drawing, the LED lamp 20 is mounted on the mounting surface 10b of the metal lamp housing 10. The heat generated by the LED lamp 20 during light emission is conducted by the mounting surface 10b to the heat dissipating block 30, which in turn absorbs the heat and dissipates the heat rapidly, thus allowing the LED lamp 20 to stay in a low-temperature state. Consequently, the LED lamp 20 is prevented from premature aging and can have a service life as long as expected.

Besides, as shown in FIG. 1 and FIG. 2, the vent holes 10c of the metal lamp housing 10 allow passage of air into and out of the metal lamp housing 10 to accelerate heat dissipation.

Furthermore, the light-reflecting surface 10a of the metal lamp housing 10 can absorb the heat inside the metal lamp housing 10 while the outer surface of the metal lamp housing 10 is exposed to the temperature of ambient air to help dissipate the heat inside the metal lamp housing 10.

It can be known from the above description that the structure of the present invention can achieve the intended effect. In addition, the present invention has never been put to public use. Therefore, the present invention meets the requirements of utility and novelty for patent application, and an application for patent of the present invention is hereby filed for examination.

It should be noted that the embodiment described above is only the preferred embodiment of the present invention. All changes or modifications which are based on the concept of the present invention and whose functions and effects do not depart from those disclosed in the present specification and the accompanying drawings should fall within the scope of the present invention, which is defined only by the appended claims.

What is claimed is:

1. A heat dissipation structure for an LED lamp, the heat dissipation structure comprising a metal lamp housing having an inner side formed with a light-reflecting surface, a plurality of vent holes, and a planar mounting surface, the heat dissipation structure being characterized in that the mounting surface is configured for mounting and positioning the LED lamp and has a backside mounted with a heat dissipating block.

2. The heat dissipation structure of claim 1, wherein the metal lamp housing has an opening provided with a light-permeable cover.

3. The heat dissipation structure of claim 1, wherein the LED lamp is mounted on the mounting surface of the metal lamp housing such that heat generated by the LED lamp during light emission is conducted by the mounting surface to the heat dissipating block, which absorbs the heat and dissipates the heat rapidly to keep the LED lamp in a low-temperature state.

4. The heat dissipation structure of claim 1, wherein the vent holes of the metal lamp housing accelerate heat dissipation by allowing air to enter and exit the metal lamp housing.

5. The heat dissipation structure of claim 1, wherein the light-reflecting surface of the metal lamp housing can absorb heat inside the metal lamp housing while an outer surface of the metal lamp housing is exposed to temperature of ambient air to assist in heat dissipation from inside the metal lamp housing.
